(19) United States
(12) Patent Application Publication
(10) Pub. No.: US 2018/0300253 A1
(43) Pub. Date: Oct. 18, 2018

(54) TRANSLATE FURTHER MECHANISM

(71) Applicants: Advanced Micro Devices, Inc., Sunnyvale, CA (US); ATI Technologies ULC, Markham (CA)

(72) Inventors: Wade K. Smith, Sunnyvale, CA (US); Anthony Asaro, Toronto (CA); Dhirendra Partap Singh Rana, Richmond Hill (CA)

(21) Appl. No.: 15/486,745

(22) Filed: Apr. 13, 2017

(51) Int. Cl. G06F 12/1009; G06F 12/1027

(52) U.S. Cl. CPC G06F 12/1009; G06F 2212/65; G06F 2212/684; G06F 12/1027

(57) ABSTRACT

Systems, apparatuses, and methods for implementing a translate further mechanism are disclosed herein. In one embodiment, a processor detects a hit to a first entry of a page table structure during a first lookup to the page table structure. The processor retrieves a page table entry address from the first entry and uses this address to perform a second lookup to the page table structure responsive to detecting a first indication in the first entry. The processor retrieves a physical address from the first entry and uses the physical address to access the memory subsystem responsive to not detecting the first indication in the first entry. In one embodiment, the first indication is a translate further bit being set. In another embodiment, the first indication is a page directory entry as page table entry field not being activated.

### BACKGROUND

### Description of the Related Art

Many computing devices use a virtual memory technique for handling data accesses by software programs. A virtual memory page-translation mechanism enables system software to create separate address spaces for each process or application. These address spaces are known as virtual address spaces. The system software uses the paging mechanism to selectively map individual pages of physical memory into the virtual address space using a set of hierarchical address-translation tables known collectively as page tables. Virtual memory can be implemented with any processor, including, but not limited to, a central processing unit (CPU), a graphics processing unit (GPU), and an accelerated processing unit (APU).

When data is accessed by a program, a block of memory of a given size (e.g., 4 kilobytes (KB)) that includes the data, called a “page” of memory, is copied from backing storage (e.g., a disk drive or semiconductor memory) to an available physical location in a main memory in the computing device. Some systems have multiple different page sizes stored in memory. Rather than having programs manage the physical locations of the pages, a memory management unit in the computing device manages the physical locations of the pages. Instead of using addresses based on the physical locations of pages (or “physical addresses”) for accessing memory, the programs access memory using virtual addresses in virtual address spaces. From a program's perspective, virtual addresses indicate the actual physical addresses (i.e., physical locations) where data is stored within the pages in memory and hence memory accesses are made by programs using the virtual addresses. However, the virtual addresses do not directly map to the physical addresses of the physical locations where data is stored. Thus, as part of managing the physical locations of pages, the memory management unit translates the virtual addresses used by the programs into the physical addresses where the data is actually located. The translated physical addresses are then used to perform the memory accesses for the programs. To perform the above-described translations, the memory management unit uses page tables in memory that include a set of translations from virtual addresses to physical addresses for pages stored in the memory. However, when a system uses multiple different page sizes, managing translations in an efficient and flexible manner can be challenging.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system.

FIG. 2 is a block diagram of one embodiment of a page translation structure.

FIG. 3 is a block diagram of another embodiment of a page translation structure.

FIG. 4 illustrates examples of different page table entry (PTE) formats.

FIG. 5 is a generalized flow diagram illustrating one embodiment of a method for implementing a translate further mechanism in page tables.

FIG. 6 is a generalized flow diagram illustrating one embodiment of a method for migrating a page from a first memory to a second memory.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for implementing a translate further mechanism in the page tables are disclosed herein. In one embodiment, a system includes at least one or more processors and a memory subsystem which stores a plurality of page sizes. In one embodiment, a processor detects a hit to a first entry during a first lookup of a page table structure. The processor performs a second lookup to the page table structure responsive to determining that the first entry includes a first indication. Alternatively, the processor accesses the memory subsystem without performing the second lookup to the page table structure responsive to determining that the first entry does not include the first indication.

In one embodiment, the first entry is a page directory entry and the first indication is a page directory entry as page table entry (PDE as PTE) field not being set, wherein the PDE as PTE field indicates whether the page directory entry should be treated as a leaf page table entry. In another embodiment, the first entry is a page table entry and the first indication is a translate further (TF) field being set. The inclusion of the TF field in page table entries allows the processor to store, in the same page table block, page table entries that target pages of different sizes. For example, in one embodiment, a first page table entry and a second page table entry are stored in the same page table block, with the first page table entry targeting, through another level of the page table structure, a page of a first size and the second page table entry targeting a page of a second size. It is assumed for the purposes of this discussion that the second size is different from the first size. In this embodiment, the first page table entry has its TF field set (i.e., equal to one), which indicates that the first page table entry targets a page of 4 KB, with the first page table entry pointing to a third page table entry in a lower-level page table block, and with the third page table entry containing the address of the targeted 4 KB page. Additionally, in this embodiment, the second page table entry has its TF field cleared (i.e., equal to zero), indicating that the second page table entry targets a page of 64 KB, with the second page table entry containing the address of the targeted 64 KB page. In other embodiments, other page sizes can be utilized other than 64 KB and 4 KB.

In one embodiment, the processor is configured to retrieve a first number of bits from the first entry responsive to determining that the first entry includes the first indication. The processor is configured to retrieve a page table entry address from the first number of bits and utilize the page table entry address to perform the second lookup of the page table structure. In one embodiment, the processor is configured to retrieve a second number of bits from the first entry responsive to determining that the first entry does not include the first indication. It is assumed for the purposes of this discussion that the second number of bits is different from the first number of bits. The processor is configured to retrieve a physical address from the second number of bits and utilize the physical address to access the memory subsystem.

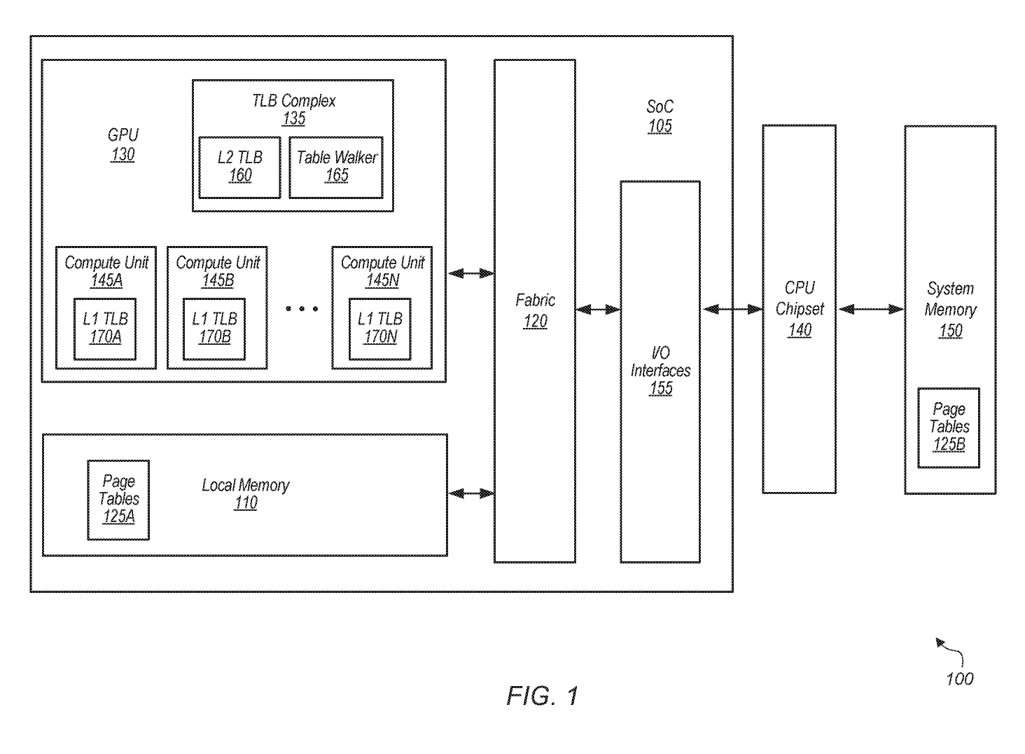

Referring now to FIG. 1, a block diagram of one embodiment of a computing system 100 is shown. In one embodiment, computing system 100 includes system on chip (SoC) 105 coupled to system memory 150. SoC 105 can also be referred to as an integrated circuit (IC). In one embodiment, SoC 105 includes at least input/output (I/O) interfaces 155, fabric 120, graphics processing unit (GPU) 130, and local memory 110. SoC 105 can also include other components not shown in FIG. 1 to avoid obscuring the figure. In another embodiment, GPU 130 can be another type of processing unit (e.g., central processing unit (CPU), application specific integrated circuit (ASIC), field programmable gate array (FPGA), digital signal processor (DSP)).

GPU 130 includes at least translation lookaside buffer (TLB) complex 135 and compute units 145A-N which are representative of any number and type of compute units that are used for graphics or general-purpose processing. GPU 130 is coupled to local memory 110 via fabric 120. In one embodiment, local memory 110 is implemented using high-bandwidth memory (HBM). In one embodiment, GPU 130 is configured to execute graphics pipeline operations such as draw commands, pixel operations, geometric computations, and other operations for rendering an image to a display. In another embodiment, GPU 130 is configured to execute operations unrelated to graphics. In a further embodiment, GPU 130 is configured to execute both graphics operations and non-graphics related operations.

In one embodiment, GPU 130 uses TLBs to cache mappings of virtual addresses to physical addresses for the virtual addresses that are allocated to different processes executing on GPU 130. These TLBs are shown as L1 TLBs 170A-N in compute units 145A-N, respectively, and L2 TLB 160 in TLB complex 135. TLB complex 135 also includes table walker 165. Generally speaking, a memory management unit can include one or more TLBs, table walking logic, fault handlers, and other circuitry depending on the implementation. In some embodiments, different TLBs can be implemented within GPU 130 for instructions and data. For example, a relatively small and fast L1 TLB is backed up by a larger L2 TLB that requires more cycles to perform a lookup. The lookup performed by an L2 TLB is relatively fast compared to a table walk to page tables 125A-B. Depending on the embodiment, page tables 125A-B can be located in local memory 110, system memory 150, or portions of page tables 125A-B can be located in local memory 110 and system memory 150. Some embodiments of a TLB complex include an instruction TLB (ITLB), a level one data TLB (L1 DTLB), and a level two data TLB (L2 DTLB). Other embodiments of a TLB complex can include other configurations and/or levels of TLBs.

In one embodiment, an address translation for a load instruction or store instruction in GPU 130 is performed by posting a request for a virtual address translation to the L1 TLB. The L1 TLB returns the physical address if the virtual address is found in an entry of the L1 TLB. If the request for the virtual address translation misses in the L1 TLB, then the request is posted to the L2 TLB. If the request for the virtual address translation misses in the L2 TLB, then a page table walk is performed for the request. A page table walk can result in one or more lookups to the page table structure (i.e., page tables 125A-B).

In one embodiment, a page table walk begins with a lookup to a page directory using a portion of the virtual address. In one embodiment, when a matching entry is found for the lookup, the page directory entry as page table entry (PDE as PTE) field is checked to see if another lookup of the page table structure should be performed. In one embodiment, the PDE as PTE field is a single bit. In another embodiment, the PDE as PTE field is a fragment field, and if the fragment field is equal to a maximum possible value (i.e., all “1” bits), then this indicates the PDE as PTE field is activated. In one embodiment, if the PDE as PTE field is activated, then a page address is retrieved from the matching entry and a lookup of memory (either local memory 110 or system memory 150) is performed using the page address. If the PDE as PTE field is not activated, then a lookup to a page table block (PTB) is performed using a PTB address retrieved from the matching entry.

When a matching entry is found during a lookup of the PTB, the translate further (TF) field is checked to see if another lookup of the page table structure should be performed. In one embodiment, the TF field is a single bit. In one embodiment, if the TF bit is set to one, then another lookup of the page table structure is performed. If the TF bit is set to one, then a PTE address is retrieved from the matching entry and used to address and locate an entry in a lower-level PTB. If the TF bit is set to zero, then a page address is retrieved from the matching entry and used to perform a lookup of the memory subsystem for the targeted page. The combination of local memory 110 and system memory 150 can be referred to herein as a “memory subsystem”. Alternatively, either local memory 110 or system memory 150 can be referred herein as a “memory subsystem”. Additionally, as used herein, the term “page” is defined as a fixed-length contiguous block of virtual memory. A “page” is also defined as a unit of data utilized for memory management by system 100. The size of a page can vary from embodiment to embodiment, and multiple different page sizes can be utilized in a single embodiment. It should be understood that the terms “memory page” and “page” are intended to represent any size of memory region.

I/O interfaces 155 are coupled to fabric 120, and I/O interfaces 155 are representative of any number and type of interfaces (e.g., peripheral component interconnect (PCI) bus, PCI-Extended (PCI-X), PCIE (PCI Express) bus, gigabit Ethernet (GBE) bus, universal serial bus (USB)). SoC 105 is coupled to system memory 150, which includes one or more memory modules. Each of the memory modules includes one or more memory devices mounted thereon. In some embodiments, system memory 150 includes one or more memory devices mounted on a motherboard or other carrier upon which SoC 105 is also mounted. In one embodiment, system memory 150 is used to implement a random access memory (RAM) for use with SoC 105 during operation. The RAM implemented can be static RAM (SRAM), dynamic RAM (DRAM), Resistive RAM (ReRAM), Phase Change RAM (PCRAM), or any other volatile or non-volatile RAM. The type of DRAM that is used to implement system memory 150 includes (but is not limited to) double data rate (DDR) DRAM, DDR2 DRAM, DDR3 DRAM, and so forth.

In various embodiments, computing system 100 can be a computer, laptop, mobile device, server or any of various other types of computing systems or devices. It is noted that the number of components of computing system 100 and/or SoC 105 can vary from embodiment to embodiment. There can be more or fewer of each component/subcomponent than the number shown in FIG. 1. It is also noted that computing system 100 and/or SoC 105 can include other components not shown in FIG. 1. For example, in another embodiment, SoC 105 can also include a central processing unit (CPU) with one or more processor cores. Additionally, in other embodiments, computing system 100 and SoC 105 can be structured in other ways than shown in FIG. 1.

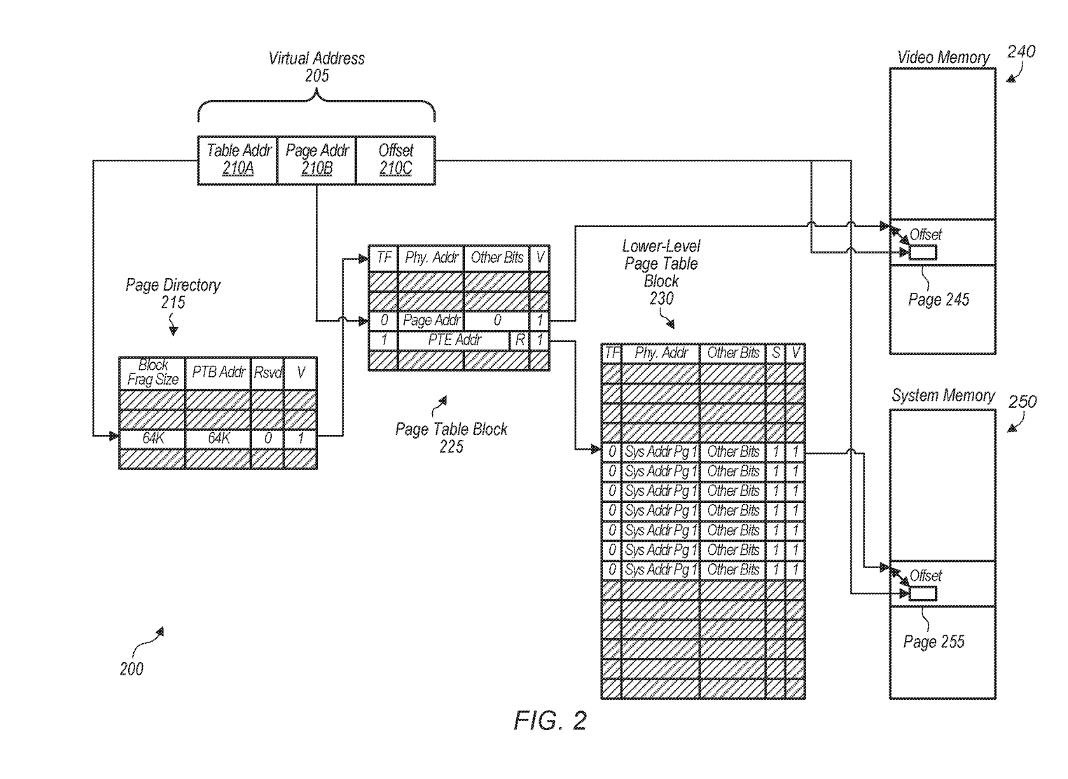

Turning now to FIG. 2, a block diagram of one embodiment of a page table structure 200 is shown. In one embodiment, the virtual address 205 is partitioned into three portions including a table address 210A, page address 210B, and offset 210C. In other embodiments, the virtual address 205 can be partitioned into other numbers of portions to facilitate other numbers of lookups to the page table structure 200. In one embodiment, the table address 210A is utilized to perform a lookup of page directory 215. The entry of page directory 215 pointed to by table address 210A includes a block fragment size field and page table block (PTB) address field which points to a particular page table block 225.

In one embodiment, the page address 210B points to a given entry of the selected page table block 225. Each entry in page table block 225 includes a translate further (TF) indicator which specifies if a further lookup of page table structure 200 is required before a physical address is obtained. In one embodiment, if the TF bit for an entry is set (i.e., equal to “1”), then the physical address field and a portion of the other bits field stores a page table entry (PTE) address which points to an entry in lower-level page table block 230. This PTE address includes more bits than can fit in the physical address field of the entry, and so a portion of the PTE address spills over into the other bits field of the entry. In lower-level page table block 230, the entry pointed to by the PTE address will be used to locate a page 255 in system memory 250.

If the TF bit is clear (i.e., equal to “0”), then the entry includes a page address in the physical address field which points to a page 245 in the video memory 240. It is noted that these designations can be reversed in another embodiment, with the TF bit equal to 0 indicating that another translation will be performed and with the TF bit equal to 1 indicating that the entry points directly to memory. It is also noted that video memory 240 can also be referred to as “local memory”.

In one embodiment, each entry in upper-level page table block 225 corresponds to a specific amount of the physical address space. For example, in one embodiment, video memory 240 stores 64 kilobyte (KB) pages and system memory 250 stores 4 KB pages. In this embodiment, each entry in upper-level page table block 225 corresponds to 64 KB of the physical address space. In other embodiments, video memory 240 and/or system memory 250 can store other page sizes.

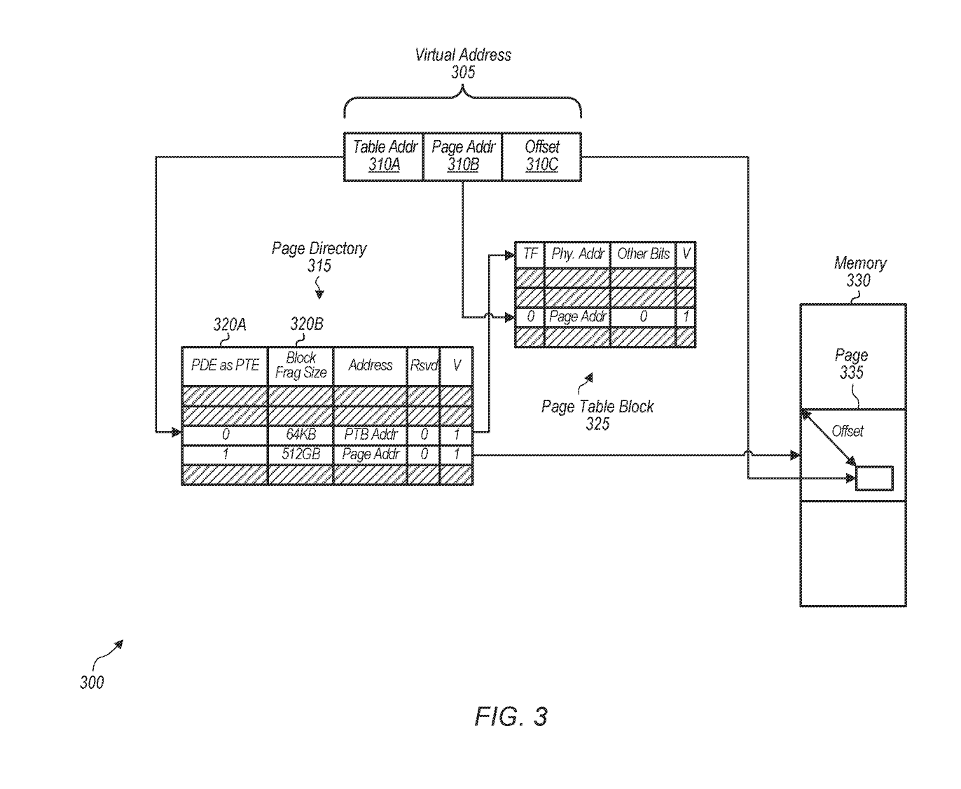

Referring now to FIG. 3, a block diagram of another embodiment of a page table structure 300 is shown. In one embodiment, a lookup of page table structure 300 is performed for virtual address 305. In one embodiment, virtual address 305 includes table address 310A, page address 310B, and offset 310C. Table address 310A is utilized to perform a lookup of page director 315 to locate a matching entry.

In one embodiment, each entry of page directory 315 includes a page directory entry as page table entry (PDE as PTE) field. In one embodiment, the PDE as PTE field 320A is a single bit. If the PDE as PTE bit is set to one, then this indicates that the entry includes a page address which points directly to memory 330 rather than to page table block 325. If the PDE as PTE bit is set to one, then the PDE is treated as if it were a leaf PTE. As used herein, a “leaf PTE” refers to an entry in the final level of the page table structure 300 which will be searched as part of the address translation. In other words, a leaf PTE includes a physical page address which points directly to physical memory. This is shown in FIG. 3 as the entry of page director 315 which points to page 335 of memory 330. Accordingly, no more lookups of page table structure 300 are performed if the entry pointed to by table address 310A has the PDE as PTE bit set to one. If the PDE as PTE bit is set to zero, then the entry includes a PTB address which points to an entry in page table block 325. This is similar to a traditional page directory entry which points to an entry in page table block 325. Accordingly, another lookup of page table structure 300 is performed, with the next lookup to page table block 325.

In another embodiment, the entries of page directory 315 do not include a separate PDE as PTE field 320A. Rather, in this embodiment, the value stored in field 320B for a given entry determines whether the given entry is treated as a PTE. For example, if the value stored in block fragment size field 320B is the maximum possible value (i.e., all “1” bits), then the entry is treated as a PTE. In other words, if the value stored in block fragment size field 320B includes all “1” bits, then this is the equivalent of having a PDE as PTE field 320A set to “1”. In other embodiments, other ways of encoding a PDE as PTE field in entries of page directory 315 are possible and are contemplated.

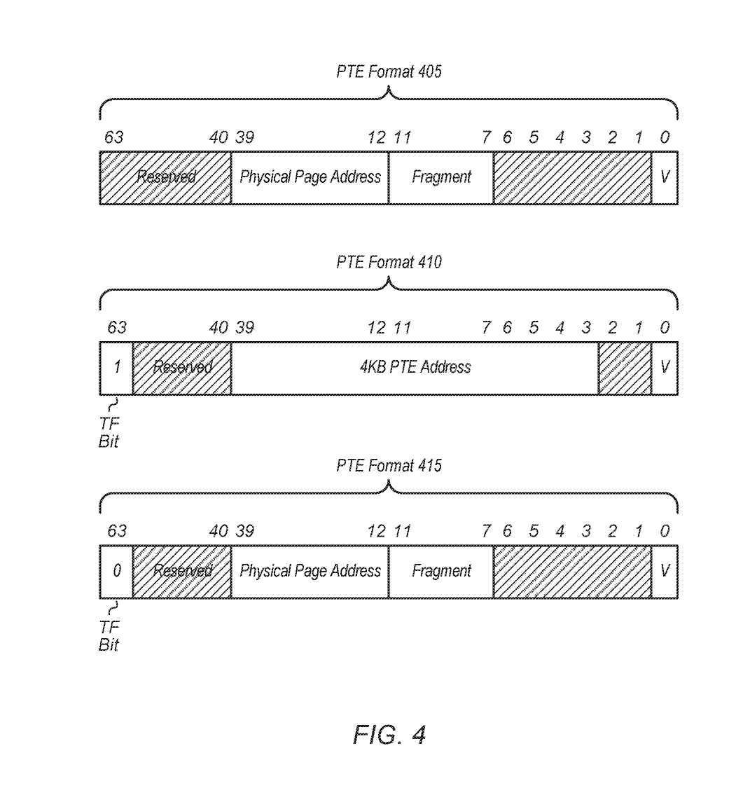

Turning now to FIG. 4, examples of different page table entry (PTE) formats are shown. PTE format 405 at the top of FIG. 4 illustrates a prior art PTE format. The physical page address is stored in bits 39 to 12, and the fragment field is stored in bits 11 to 7. In one embodiment, the fragment field provides directives regarding the degree of fragmentation of the physical address space. In one embodiment, a page pointed to by the physical page address in PTE format 405 is 4 KB in size. Accordingly, in this embodiment, there is one PTE for each 4 KB logical page of addressable memory.

PTE format 410 in the middle of FIG. 4 illustrates a new PTE format when the translate further (TF) bit is set to one. When the TF bit=1, bits 39 to 3 store the 4 KB PTE address. In one embodiment, the 4 KB PTE address is 8 byte aligned allowing the address to point to any PTE in a lower-level page table block. PTE format 415 at the bottom of FIG. 4 illustrates a new PTE format when the TF bit is set to zero. When the TF bit=0, bits 39 to 12 store the physical page address and bits 11 to 7 store the fragment field. It should be understood that the PTE formats 410-415 shown in FIG. 4 are examples of PTE formats that can be used in one embodiment. In other embodiments, other types of PTE formats for storing a TF indicator, PTE address, and physical page address are possible and are contemplated.

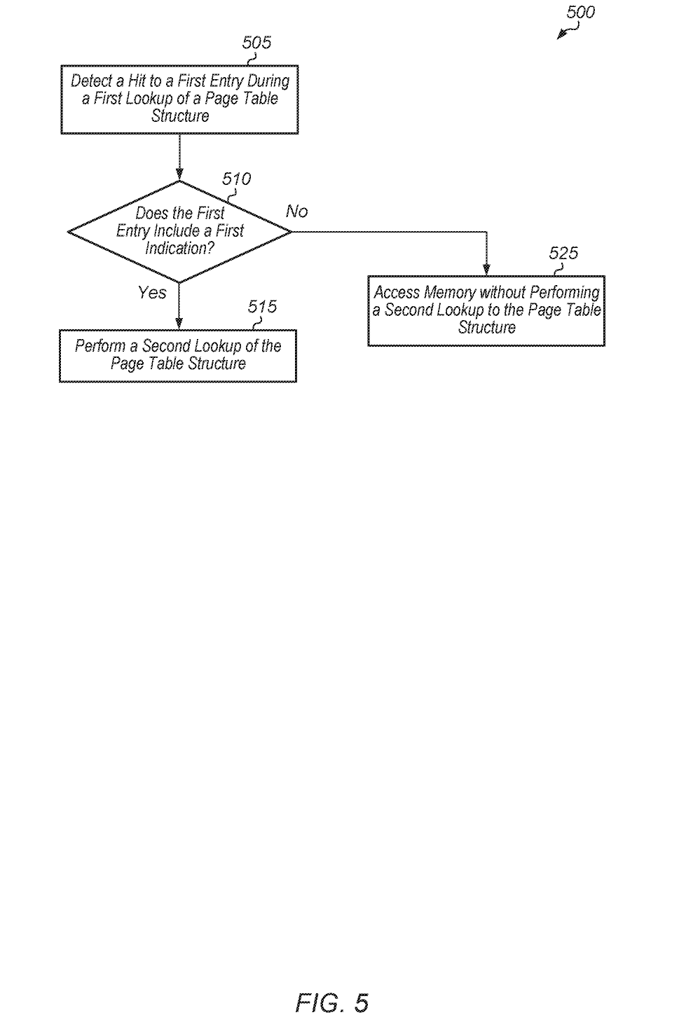

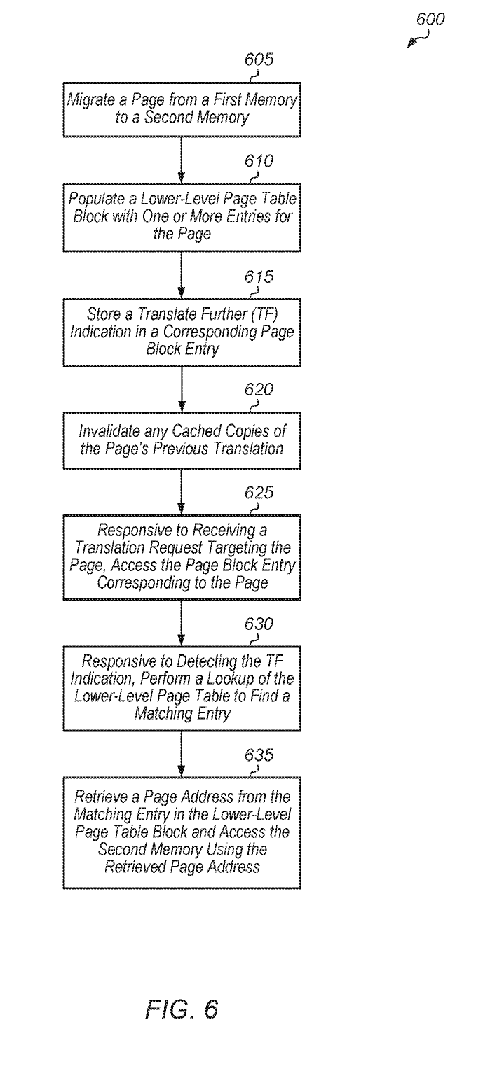

Referring now to FIG. 5, one embodiment of a method 500 for implementing a translate further mechanism in a page table structure is shown. For purposes of discussion, the steps in this embodiment and those of FIG. 6 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

A processor detects a hit to a first entry during a first lookup of a page table structure for a given virtual address (block 505). It is noted that the term “first lookup” is in the context of method 500. In some cases, the first lookup can be subsequent to one or more previous lookups to the page table structure. Alternatively, the first lookup referred to in block 505 can be the initial lookup to the page table structure for the given virtual address. In one embodiment, the first lookup referred to in block 505 is performed to a page directory. In another embodiment, the lookup referred to in block 505 is performed to a page table block. In one embodiment, the processor is part of a system (e.g., system 100 of FIG. 1) that also includes at least a memory management unit (MMU) and a memory subsystem. The system can also include any number of other components depending on the embodiment.

Next, the processor determines if the first entry includes a first indication (conditional block 510). In one embodiment, the first indication is a translate further (TF) bit being set. In another embodiment, the first indication is a page directory entry as page table entry (PDE as PTE) field not being activated. In other embodiments, the first indication can be other types of indications.

If the first entry includes the first indication (conditional block 510, “yes” leg), then the processor performs a second lookup of the page table structure (block 515). It is noted that the term “second lookup” refers to a lookup performed subsequent to the “first lookup” referred to in block 505. In one embodiment, the processor retrieves a page table entry address from the first entry and uses the page table entry address to perform a lookup of a lower level table of the page table structure. In one embodiment, the page table entry address has a first number of bits. In another embodiment, the processor retrieves a page table block address from the first entry and uses the page table block address to locate a particular page table block. Then, in this embodiment, the processor performs a lookup of the particular page table block to find a matching entry.

If the first indication is not detected in the first entry (conditional block 510, “no” leg), then the processor accesses memory without performing a second lookup to the page table structure (block 520). In one embodiment, the processor retrieves a physical address from the first entry and utilizes the physical address to access the memory. In one embodiment, the physical address has a second number of bits, wherein the second number of bits is different from the first number of bits. After blocks 515 and 520, method 500 ends.

Turning now to FIG. 6, one embodiment of a method 600 for migrating a page from a first memory to a second memory is shown. A system migrates a page from a first memory to a second memory (block 605). In one embodiment, the first memory is a local memory and the second memory is a system memory. In one embodiment, pages have a first size in the first memory and pages have a second size in the second memory, wherein the second size is different from the first size. In one embodiment, the first size is larger than the second size.

In response to migrating the page from the first memory to the second memory, system software populates a lower-level page table block with one or more entries for the page (block 610). Additionally, system software stores a translate further (TF) indication in a corresponding page block entry (block 615). Also, any cached copies of the page's previous translation are invalidated (block 620).

Next, at a later point in time, responsive to receiving a translation request targeting the page, the processor accesses the page block entry corresponding to the page (block 620). Responsive to detecting the TF indication, the processor performs a lookup of a lower-level page table block to find a matching entry (block 625). Next, the processor retrieves a page address from the matching entry in the lower-level page table block and accesses the second memory using the retrieved page address (block 630). After block 630, method 600 ends.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a memory subsystem which stores pages with a plurality of page sizes; and
a processor;
wherein the processor is configured to;
detect a hit to a first entry during a first lookup of a page table structure;
responsive to determining that the first entry includes a first indication, perform a second lookup of the page table structure; and
responsive to determining that the first entry does not include the first indication, access the memory subsystem without performing the second lookup of the page table structure.

2. The system as recited in claim 1, wherein responsive to determining that the first entry includes the first indication, the processor is configured to retrieve a first number of bits from the first entry.

3. The system as recited in claim 2, wherein responsive to determining that the first entry does not include the first indication, the processor is configured to retrieve a second number of bits from the first entry, wherein the second number of bits is different from the first number of bits.

4. The system as recited in claim 3, wherein responsive to determining that the first entry includes the first indication, the processor is configured to:
retrieve a page table entry address from the first number of bits; and
utilize the page table entry address to perform the second lookup of the page table structure.

5. The system as recited in claim 4, wherein responsive to determining that the first entry does not include the first indication, the processor is configured to:
retrieve a physical address from the second number of bits; and
utilize the physical address to access the memory subsystem.

6. The system as recited in claim 1, wherein:
the first entry is a page directory entry; and
the first indication is a page directory entry as page table entry (PDE as PTE) field not being activated, wherein the PDE as PTE field indicates whether the page directory entry should be treated as a leaf page table entry.

7. The system as recited in claim 1, wherein:
the first entry is a page table entry; and
the first indication is a translate further bit being set.

8. A method comprising:
detecting a hit to a first entry during a first lookup of a page table structure;
responsive to determining that the first entry includes a first indication, performing a second lookup to the page table structure; and
responsive to determining that the first entry does not include the first indication, accessing a memory subsystem without performing the second lookup to the page table structure.

9. The method as recited in claim 8, wherein responsive to determining that the first entry includes the first indication, the method further comprising retrieving a first number of bits from the first entry.

10. The method as recited in claim 9, wherein responsive to determining that the first entry does not include the first indication, the method further comprising retrieving a second number of bits from the first entry, wherein the second number of bits is different from the first number of bits.

11. The method as recited in claim 9, wherein responsive to determining that the first entry includes the first indication, the method further comprising:
retrieving a page table entry address from the first number of bits; and
utilizing the page table entry address to perform the second lookup of the page table structure.

12. The method as recited in claim 11, wherein responsive to determining that the first entry does not include the first indication, the method further comprising:
retrieving a physical address from the second number of bits; and
utilizing the physical address to access the memory subsystem.

13. The method as recited in claim 8, wherein:
the first entry is a page directory entry; and
the first indication is a page director entry as page table entry (PDE as PTE) field not being activated, wherein the PDE as PTE field indicates whether the page directory entry should be treated as a leaf page table entry.

14. The method as recited in claim 8, wherein:
the first entry is a page table entry; and
the first indication is a translate further bit being set.

15. An apparatus comprising:
a memory subsystem; and
a memory management unit;
wherein the apparatus is configured to:
detect a hit to a first entry during a first lookup of a page table structure;
responsive to determining that the first entry includes a first indication, perform a second lookup to the page table structure; and
responsive to determining that the first entry does not include the first indication, access the memory subsystem without performing the second lookup to the page table structure.

16. The apparatus as recited in claim 15, wherein responsive to determining that the first entry includes the first indication, the processor is configured to retrieve a first number of bits from the first entry.

17. The apparatus as recited in claim 16, wherein responsive to determining that the first entry does not include the first indication, the apparatus is configured to retrieve a second number of bits from the first entry, wherein the second number of bits is different from the first number of bits.

18. The apparatus as recited in claim 17, wherein responsive to determining that the first entry includes the first indication, the apparatus is configured to:
retrieve a page table entry address from the first number of bits; and
utilize the page table entry address to perform the second lookup of the page table structure.

19. The apparatus as recited in claim 18, wherein responsive to determining that the first entry does not include the first indication, the apparatus is configured to:
retrieve a physical address from the second number of bits; and
utilize the physical address to access the memory subsystem.

20. The apparatus as recited in claim 15, wherein:
the first entry is a page directory entry; and
the first indication is a page director entry as page table entry (PDE as PTE) field not being activated, wherein the PDE as PTE field indicates whether the page directory entry should be treated as a leaf page table entry.
